(19) United States
(12) Patent Application Publication
(10) Pub. No.: US 2018/0273118 A1
(43) Pub. Date: Sep. 27, 2018

(54) Motorized baby stroller

(71) Applicant: Corban Perry, Wynne, AR (US)

(72) Inventor: Corban Perry, Wynne, AR (US)

(21) Appl. No.: 15/469,541

(22) Filed: Mar. 26, 2017

(51) Int. Cl. B62D 47/00; B60Q 5/00; B60Q 1/00; B60L 11/18; B60L 15/28

(52) U.S. Cl. CPC B62D 47/00; B60Q 5/001; B60Q 1/0076; B60W 30/18; B60L 11/1861; B60L 15/28; B60W 2710/081; B60L 11/18

(57) ABSTRACT

A motorized baby stroller for transporting a baby may include a front section; a side section connected to the front section and a back section connected to the side section. The front section may include a motor to drive a wheel of the motorized baby stroller. The front section may include a cavity to hold the baby; wherein the front section includes a proximity detector to detect a baby in the cavity, and the motor may be controlled by the proximity detector.

### FIELD OF THE INVENTION

The present invention relates to baby strollers and more particularly to a motorized baby stroller.

### BACKGROUND

Conventional baby strollers (i.e., non-motorized strollers) have been known and used for many years. When the child who is to be transported in the stroller is an infant, the stroller is relatively easy to push. However, as the child grows and gains weight, or when packages are attached to the stroller while shopping, the stroller becomes increasingly difficult to push. In addition, when the stroller is to be moved up an incline, the person pushing the stroller may have substantial difficulty in traversing the incline. This is especially true when the person pushing the stroller has a physical ailment (i.e., orthopedic or muscular), is a small framed person, or is elderly.

### SUMMARY

A motorized baby stroller for transporting a baby may include a front section; a side section connected to the front section and a back section connected to the side section.

The front section may include a motor to drive a wheel of the motorized baby stroller. The front section may include a cavity to hold the baby; wherein the front section includes a proximity detector to detect a baby in the cavity, and the motor may be controlled by the proximity detector.

The side section may include a control panel to control the baby stroller.

The control panel may include a battery meter.

The control panel may include a switch to control lights.

The control panel may include a switch to control a horn.

The control panel may include a switch to control the speed of the baby stroller.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a side view of a motorized baby stroller of the present invention;

FIG. 2 illustrates a top view of the motorized baby stroller of the present invention;

FIG. 3 illustrates a top view of the control panel of the motorized baby stroller of the present invention.

### DETAILED DESCRIPTION

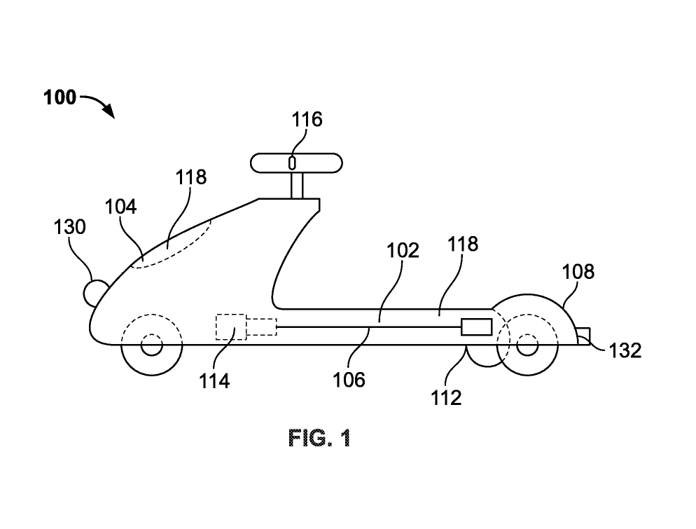

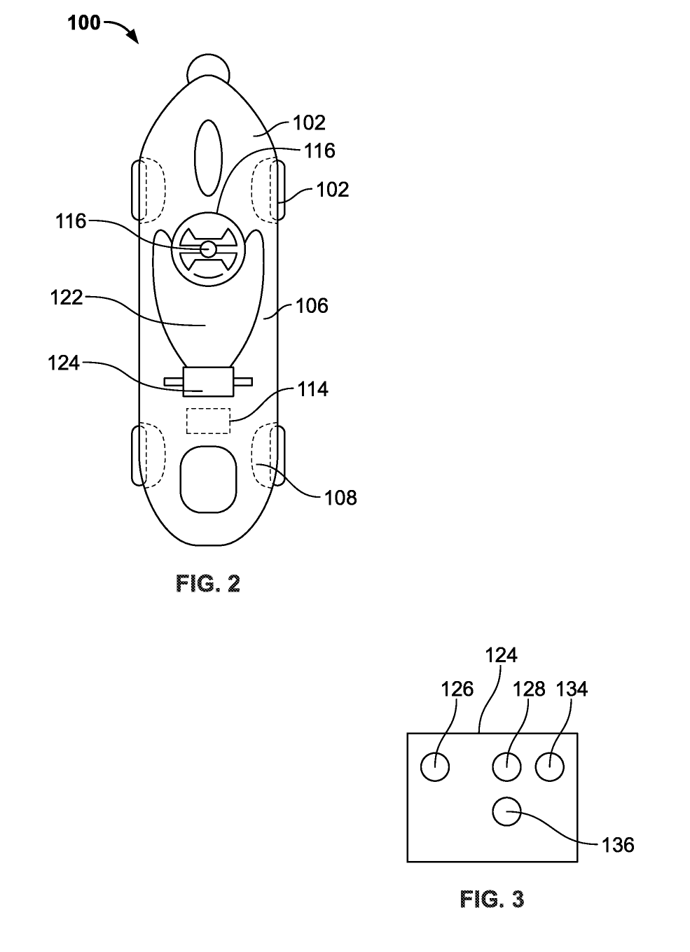

FIG. 1 illustrates a side view of the motorized baby stroller 100 of the present invention which may include a stroller main body 102, and the stroller main body 102 may include a front section 104, a side section 106 which may be connected to the front section 104 and a back section 108 which may be connected to the side section 106. The front section 104 may include a front wheel 110. The front wheel 110 may be responsive and connected to the handle bars 116 to pivot the front wheel 110 to allow the motorized baby stroller 100 to be turned. The motor 112 may be battery-operated by a battery 114. The front section 104 may include a cavity/cabin 118 positioned in the upper surface of the front section 104 to hold the baby while being transported in the motorized baby stroller 100. The front section 104 may include a restraining device 116 (shown in FIG. 2) which may include a lattice of flexible cords/springs which may extend across the interior of the cavity in order to support the baby without allowing the baby to be injured as a result of travel over uneven surfaces. The restraining device 116 may include a proximity detector 118 (shown in FIG. 2) to detect the presence of the baby and to control a switch to prevent the motor from operating unless the proximity detector 118 detects the baby.

The side section 106 may include a platform surface 122 to allow the user to operate the motorized baby stroller 100 and may include the handle bars 116 mounted on a raised portion of the stroller main body 102 to allow the user to steer the motorized baby stroller 100. The side section 106 may include a control panel 124 to operate the motorized baby stroller 100. The control panel 124 may include a battery meter 126 to provide an indication of the battery level, a light switch 128 to operate the front lights 130 and the taillights 132, a horn switch 134 to activate and deactivate a horn to warn of the approach of the motorized baby stroller 100 and a speed switch 136 to control the speed of the motor 112 to control the speed of the motorized baby stroller 100.

The back section 108 may include a back wheel 140 which may be connected to a motor 112 which may connect to the back wheel 140 with gears or belts and a taillight 132.

FIG. 2 illustrates a top view of the motorized baby stroller 100 of the present invention which may include a stroller main body 102 and the stroller main body 102 may include a front section 104, a side section 106 which may be connected to the front section 104 and a back section 108 which may be connected to the side section 106. The front section 104 may include a front wheel 110. The front wheel 110 may be responsive and connected to the handle bars 116 to pivot the front wheel 110 to allow the motorized baby stroller 100 to be turned. The motor 112 may be battery-operated by a battery 114. The front section 104 may include a cavity/cabin 118 positioned in the upper surface of the cavity 118 to hold the baby while being transported in the motorized baby stroller 100. The front section 104 may include a restraining device 116 (shown in FIG. 2) which may include a lattice of flexible cords/springs which may extend across the interior of the cavity in order to support the baby without allowing the baby to be injured as a result of travel over uneven surfaces. The restraining device 116 may include a proximity detector 118 (shown in FIG. 2) to detect the presence of the baby and to control a switch to prevent the motor from operating unless the proximity detector 118 detects the baby.

The side section 106 may include a platform surface 122 to allow the user to operate the motorized baby stroller 100 and may include the handle bars 116 mounted on a raised portion of the stroller main body 102 to allow the user to steer the motorized baby stroller 100. The side section 106 may include a control panel 124 to operate the motorized baby stroller 100. The control panel 124 may include a battery meter 126 (not shown in FIG. 2) to provide an indication of the battery level, a light switch 128 (not shown in FIG. 2) to operate the front lights 130 and the taillights 132, a horn switch 134 (not shown in FIG. 2) to activate and deactivate a horn to warn of the approach of the motorized baby stroller 100 and a speed switch 136 (not shown in FIG. 2) to control the speed of the motor 112 and to control the speed of the motorized baby stroller 100.

The back section 108 may include a back wheel 140 which may be connected to a motor 112 which may connect to the back wheel 140 with gears or belts and a taillight 132.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A motorized baby stroller for transporting a baby, comprising:
a front section;
a side section connected to the front section;
a back section connected to the side section;
wherein the front section includes a motor to drive a wheel of the motorized baby stroller; wherein the front section includes a cavity to hold the baby; wherein the front section includes a proximity detector to detect a baby in the cavity; wherein the motor is controlled by the proximity detector.

2) A motorized baby stroller for transporting a baby as in claim 1, wherein the side section includes a control panel to control the baby stroller.

3) A motorized baby stroller for transporting a baby as in claim 2, where in the control panel includes a battery meter.

4) A motorized baby stroller for transporting a baby as in claim 2, wherein the control panel includes a switch to control lights.

5) A motorized baby stroller for transporting a baby as in claim 2, wherein the control panel includes a switch to control a horn.

6) A motorized baby stroller for transporting a baby as in claim 2, wherein the control panel includes a switch to control the speed of the baby stroller.
